(19) United States
(12) Patent Application Publication
(10) Pub. No.: US 2009/0100336 A1
(43) Pub. Date: Apr. 16, 2009

(54) METHODS AND SYSTEMS FOR COMMUNICATING DATA

(76) Inventors: John J. Powley, Plainville, MA (US); Robert Gendron, Salem, MA (US)

Correspondence Address: General Electric Company;GE Global Patent Operation, PO Box 861, 2 Corporate Drive, Suite 648, Shelton, CT, 06484, US

(21) Appl. No.: 11/871,466

(22) Filed: Oct. 12, 2007

(51) Int. Cl. G06F 3/00

(52) U.S. Cl. 715/700

(57) ABSTRACT

Methods and systems for normalizing client access to data are provided. In one aspect, a method for accessing data in an automation system is provided. The method includes publishing at least one resource for at least one device and transmitting, from a client to the at least one device, a request to identify any available operations for the at least one published resource. The method also includes transmitting to the client a user interface generated by the at least one device in response to a client request for information relating to a chosen operation of the at least one published resource, and displaying results of the chosen operation in response to a client request to execute the chosen operation.

### BACKGROUND OF THE INVENTION

This invention relates generally to client software interfaces used to communicate within a system and, more specifically, to normalizing configuration and runtime data communication within a system.

In at least some known systems, client programming requires specialized knowledge of the possible interactions between the client software and multiple disparate devices. In such systems, each device has a proprietary configuration interface and a data access interface that the client must satisfy to provide end user functionality. Additionally, in at least some known environments, client programming requires in-depth knowledge of each individual device and the client software in order to interact with each device. Accordingly, as the number of devices increases, the complexity of the business logic orchestration also increases.

The automation industry, for example, has a number of available standards that attempt to normalize client interaction with device data. For example, Electronic Device Description Language (EDDL) uses metadata descriptions and a set of interfaces that clients can leverage to consistently access device data. Another example is Ole for Process Control (OPC), which is a set of interfaces that provide tools for configuration and data access to devices. However, as a result of their reliance on metadata, both of these standards normally suffer from poor client domain inference from the metadata and therefore may have limited configuration and business logic support.

### BRIEF DESCRIPTION OF THE INVENTION

In one aspect, a method for accessing data in an automation system is provided. The method includes publishing at least one resource for at least one device and transmitting, from a client to the at least one device, a request to identify any available operations for the at least one published resource. The method also includes transmitting to the client a user interface generated by the at least one device in response to a client request for information relating to a chosen operation of the at least one published resource, and displaying results of the chosen operation in response to a client request to execute the chosen operation.

In another aspect, an automation communication system is provided. The system includes a network, at least one client device communicatively coupled to the network, at least one service provider including a plurality of methods and resources, wherein the at least one service provider is communicatively coupled to the network, and at least one server communicatively coupled to the network. The at least one server is configured to extract and publish in a directory each available method and resource using an interface of the at least on service provider, transmit to the at least one service provider a request from the at least one client device for a list of the plurality of methods, transmit to the at least one client device a user interface developed by the at least one service provider, wherein the user interface is one of a method configuration user interface and a method results user interface, and transmit to the at least one client device data results for display, wherein the data results are generated in response to a request from the at least on client device to execute a particular method of the plurality of methods.

In another aspect, a system for normalizing data access by clients in an automation system is provided. The system includes a network, at least one client communicatively coupled to the network, at least one device including a plurality of public resources and at least one interface, wherein the at least one device is communicatively coupled to the network, and at least one application server communicatively coupled to the network. The at least one application server includes a publisher and an I/O engine. The publisher is configured to extract and publish in a directory each available public resource using the at least one interface of the at least one device. The I/O engine is configured to provide to the at least one client an attribute list for a specific public resource and a list of methods that may be executed by the specific public resource, provide to the at least one client a customized user interface panel generated by the specific public resource, and provide data results to the at least one client in response to a request from the at least one client to execute a specific method by the at least one device, wherein the data results are displayed to a user using one of the customized user interface panel and a user interface provided by the at least one client.

### BRIEF DESCRIPTION OF THE DRAWINGS

FIGS. 1-3 show exemplary embodiments of the systems and methods described herein. The systems and methods shown in FIGS. 1-3 and described in conjunction with FIGS. 1-3 are exemplary only.

FIG. 1 is a block diagram illustrating an exemplary interface architecture that may be used with an automation system;

FIG. 2 is a block diagram illustrating an exemplary hardware architecture that may be used with the automation system shown in FIG. 1; and

FIG. 3 is a flow chart illustrating an exemplary method of communicating in an automation system, such as the automation system shown in FIGS. 1 and 2.

### DETAILED DESCRIPTION OF THE INVENTION

Set forth below are descriptions of exemplary methods and systems for use in communicating data in an automation system. The methods and systems facilitate normalizing configuration and runtime data access in automation systems using a set of interface definitions to communicate with devices to enable clients to become aware of the properties and resources associated with each device. The methods and systems are not limited to the specific embodiments described herein. Rather, in addition, components of each system and steps of each method can be practiced independent and separate from other components and steps described herein. Moreover, each component and step can also be used in combination with other components and steps. As such, the technical effect of the described embodiments is to normalize communication between clients and service providers in an automated system configured to perform base services.

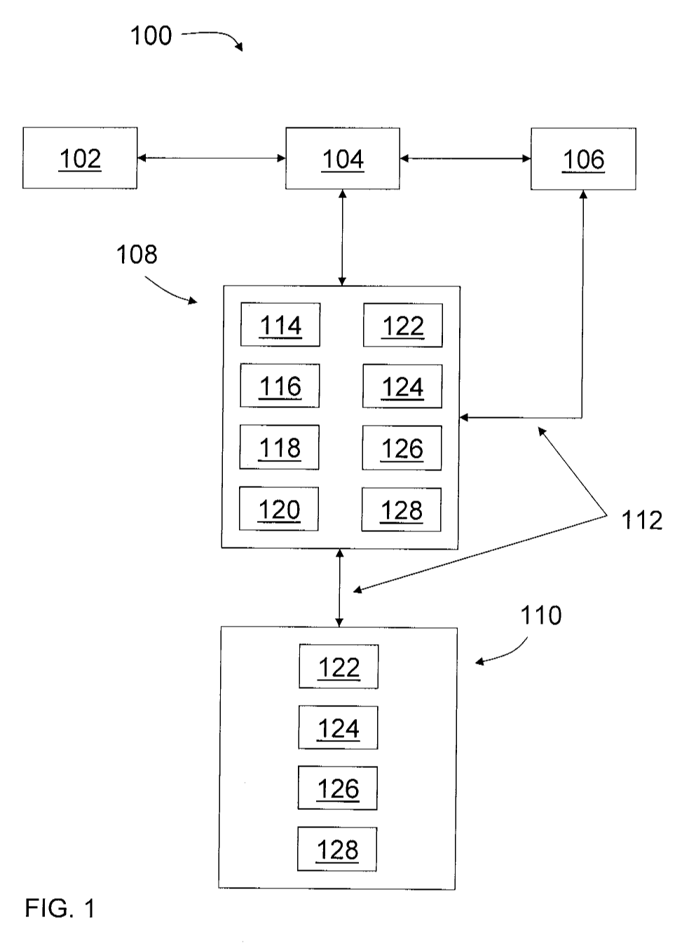

FIG. 1 illustrates a block diagram of an exemplary interface architecture that can be used with an automation communication system. The system can be implemented on a variety of different platforms and may use many different architectures. Accordingly, the architectures illustrated in FIG. 1 are exemplary only.

In the exemplary embodiment, an automation communication system 100 includes at least one client 102, a local directory of resources 104, a global directory of resources 106, a group of distributed applications 108, and at least one data source 110. System 100 is interconnected by a network 112. Client 102 is communicatively coupled to network 112. A user accesses, such as via dialing into, or directly logging into, an intranet or the Internet to gain access to system 100. In one embodiment, a user must enter a valid user name and valid user password to access system 100. The user name and user password correspond to, for example, a user profile that may be stored and/or embodied by a distributed application 108.

The local directory of resources (Local DOR) 104 enables a user to access distributed applications 108 and/or data sources 110 that the user has previously accessed by browsing global directory of resources (Global DOR) 106. In the exemplary embodiment, Local DOR 104 is a client-side cache of data sources 110 derived from Global DOR 106. Alternatively, Local DOR 104 may be a stand-alone set of data sources 110 derived from Global DOR 106. Global DOR 106 provides access to all properties of available data sources 110.

In the exemplary embodiment, distributed applications 108 include model storage 114, services 116, a publisher 118, and an input/output (I/O) engine 120. Model storage 114 and services 116 provide a set of interfaces that are used to communicate throughout system 100. Publisher 118 is configured to query each data source 110 for all available data for each data source 110 such as, but not limited to, configuration parameters and available methods that may be called. I/O engine 120 is configured to collect data requests by client 102, aggregate the requests into batches, send the batches to the appropriate destination, collect batch results, and unpack and send the individual request results to client 102. The set of interfaces supported by distributed applications 108 includes a browsing and querying interface (Browse IF) 122, an interface that identifies all published programming functionality for a data source 110 (MetaData IF) 124, a data exchange access interface (Data IF) 126, and a custom programming support interface (Config IF) 128. Each interface is described in more detail below.

System 100 also includes at least one data source 110. Each data source 110 may be an automation system device such as, but not limited to, a paint machine and/or a data sensor. Each data source 110 includes the interfaces 122, 124, 126, and 128 introduced above.

In the exemplary embodiment, system interfaces 122, 124, 126, and 128 are provided by distributed applications 108. System 100 utilizes interfaces 122, 124, 126, and 128 to publish, for example, Global DOR 106. Moreover, client 102 caches properties of each data source 110 in Local DOR 104 and obtains access to each data source 110 and distributed applications 108 from information stored in both Local DOR 104 and Global DOR 106.

In the exemplary embodiment of system 100, Browse IF 122 identifies public resources of data sources 110 and can be used by programs or applications. In a broad sense, Browse IF 122 obtains information used to populate Global DOR 106, wherein the information is general content that defines, for example, the name and key attributes that are populated. Browse IF 122 and publisher 118 cooperate to build Global DOR 106. Specifically, publisher 118 provides programming support that interrogates or queries Browse IF 122 for a concrete system, such as a data source 110. The content of a Browse IF 122 request, as returned by a data source 110 to publisher 118, is used to construct an object in Global DOR 106. In so doing, publisher 118 queries Browse IF 122 with a set of requested information. In the exemplary embodiment, the set of requested information is communicated to Browse IF 122 as an Extensible Markup Language (XML) document fragment that includes a scheme to be populated by Browse IF 122. A process that implements Browse IF 122 for data source 110 also populates the fields of the XML document fragment. In an alternative embodiment, the implementer also embeds, into the XML document fragment, customized fields that are local to the particular data source 110. Publisher 118 uses the returned XML document fragment to create Global DOR 106 in a tree or parent-child format.

Browse IF 122 is supported by each distributed application 108 and each data source 110 of system 100. In the exemplary embodiment, Browse IF 122 includes a plurality of methods that may be executed to obtain information regarding a specific data source 110 or about a group of data sources 110. In the exemplary embodiment, a method is provided that obtains information regarding a number of child objects of a specified node. Methods are also provided that identify the children of a specified node to enable properties of interest of each child to be obtained. The methods and fields provided by Browse IF 122 are used to build Global DOR 106 to facilitate visual browsing from client 102.

In the exemplary embodiment of system 100, MetaData IF 124 identifies all programming functionality published by each data source 110. In general, metadata has a large number of uses. For example, metadata enables computing entities that form solutions to be described rather than merely outputting binary results. Information in a metadata description may be used by client programs to combine computing elements. In the exemplary embodiment, MetaData IF 124 includes “general” metadata that includes an attribute list for a data source 110, “prototype” metadata that defines all programmability for a property or method of a data source 110, “results data” metadata that defines standard data forms, and metadata specific to Config IF 128 that facilitates customizing programming for a data source 110. Alternative embodiments may includes more or fewer types of metadata, or other types of metadata.

General metadata, as used herein, is descriptive only and includes, for example, but without limitation, simple attribute lists for a data source 110, software version information, and descriptive help information. In the exemplary embodiment, general metadata is presented in a number of storage formats, including, but not limited to, initialization (INI) files, XML files, and relational database tables. A general metadata object is included in Global DOR 106 and, therefore, may also be included in Local DOR 104 such that client 102 may access the definition and may use it. For example, an installation program may query Global DOR 106 to find version matches and/or mismatches between available versions during an installation.

Prototype metadata, as used herein, includes, but is not limited to only including, a list of interfaces supported by a data resource 110 or distributed application 108, a list of methods supported by a given interface 122, 124, 126, and 128, and a description of a particular method including a method name, metadata of return values, metadata of input parameters, and metadata of output parameters. Moreover, prototype metadata includes event descriptions, such as an event name, and metadata for input parameters, such as data source 110 property descriptions including a property name, input type, and return type.

Results data metadata includes, without limitation, a classification of data that may be returned from a method execution. Config IF metadata includes, but is not limited to including, a list of configuration parameters for a particular data source 110, a loadable program proxy for configuring custom information, and a loadable program proxy for customizing an interface.

In the exemplary embodiment, Data IF 126 defines the data exchange access interface and data access formats. Data IF 126 supports a wide range of data servers, data containers, and data formats by striking a balance between generality and customization. From the standpoint of a client 102, the client 102 may query Data IF 126 directly for data retrieval and/or method execution. Data IF 126 includes a plurality of methods that each belong to a category. For example, one category includes methods that determine supported create, read, update, delete, and execute (CRUDE) operations. In the exemplary embodiment, a second category includes methods that affect input and output execution, including status completion methods and I/O status control methods. Moreover, a third category includes methods that determine supported data formats for clients 102 and data sources 110. In addition, the exemplary embodiment includes a fourth category including methods directed to the delivery of data in requested data formats and associated metadata.

In the exemplary embodiment, Data IF 126 uses the methods of each of the above categories for three basic modes of operation. The first mode of operation includes setup or configuration operations wherein the programmability and use of a resource of a data source 110 is determined. The second mode of operation includes the runtime execution of methods, including data requests from a data resource 110. The third mode of operation includes data format selection and data access operations, wherein client 102 obtains data from data source 110 in a particular format.

In the exemplary embodiment, Config IF 128 identifies and supports custom programming for displaying data access and manipulating results of data resource 110, on client 102. Config IF 128 also provides programmability for a user interface (UI) for use with client 102 such as, but not limited to, a custom panel that presents a UI and may be embedded in a main UI frame. Such a custom panel includes a client proxy code that communicates with data source 110 and/or one or more distributed applications 108. Moreover, Config IF 128 provides validation logic to data source 110 and distributed applications 108, wherein the validation logic facilitates ensuring, for example, correct data field names and correct data types to be included in each field. Furthermore, Config IF 128 facilitates the exchange of custom attributes for data source 110 by client 102, distributed applications 108, and data source 110. In the exemplary embodiment, each implementation of Config IF 128 supports the creation of a custom UI control panel and data validation. Moreover, in the exemplary embodiment, Config IF 128 supports calling a custom UI to execute a method and, further, supports calling a custom UI to configure parameters required to execute a method using MetaData IF 124 and a set of Config IF metadata specific to the method. An alternative embodiment includes an implementation of Config IF 128 that supports only data validation. For an implementation such as data source 110 or distributed application 108 to support creation of a custom UI panel, the implementation must also support data validation.

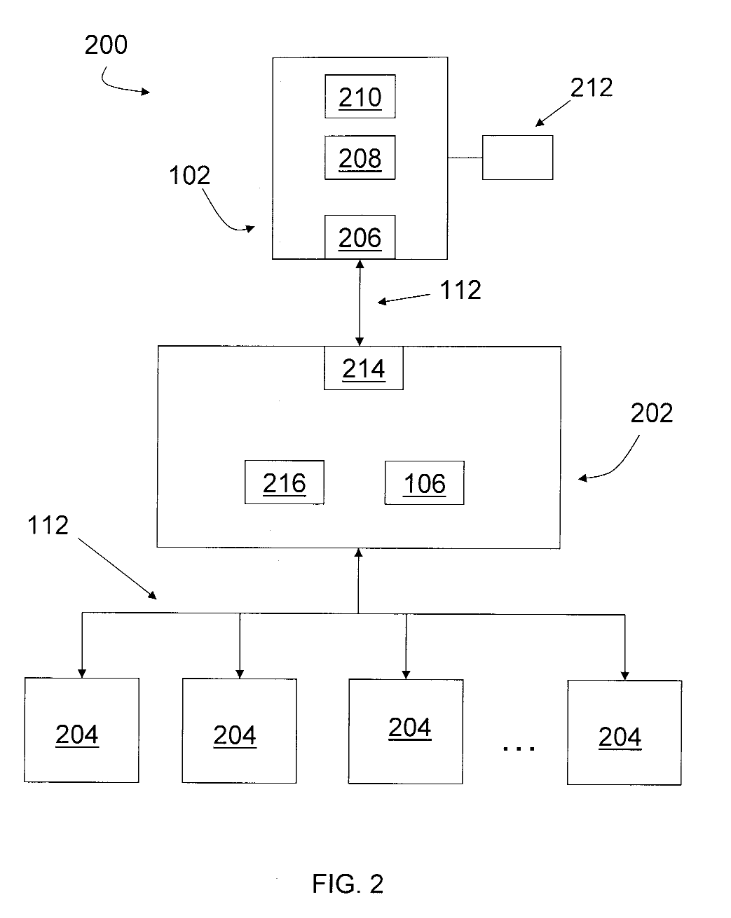

FIG. 2 illustrates a block diagram of an exemplary hardware architecture 200 that can be utilized in conjunction with automation communication system 100 (shown in FIG. 1). System 100 can be implemented on many different platforms and utilize many different architectures. The architectures illustrated in FIG. 2 are exemplary only.

In the exemplary embodiment, architecture 200 includes at least one client device, such as client 102, at least one server 202, and at least one device 204. Architecture 200 is interconnected by network 112. In one embodiment, network 112 is a wide area network (WAN), such as the Internet. In another embodiment, network 112 is a local area network (LAN), such as an intranet. Network 112 includes the physical medium and intermediate devices (not shown), such as routers and switches, that connect the elements of system 100 described above.

Client 102 is communicatively coupled to network 112 via a network interface 206. A user accesses, such as dialing into, or directly logging into, an intranet or the Internet to gain access to architecture 200. Client 102 may connect to network 112 through many interfaces including a different network (not shown), such as a WAN or a LAN, dial in connections, cable modems, wireless networks, and special high-speed ISDN lines. Client 102 is any device capable of interconnecting to network 112, including a web-based telephone or other web-based connectable equipment. Client 102 may be a stand-alone client, such as a thin client, that runs only an operating system and an application for accessing and communicating with architecture 200. Alternatively, client 102 may operate as an application that is installed on a personal computer (PC) and may be run similarly and/or concurrently with other programs. Client 102 also includes a system memory 208 that is electrically coupled to a system bus (not shown) and, in one embodiment, includes an operating system and a user-oriented program and data. In the exemplary embodiment, memory 208 includes a client-side cache that hosts a local directory of resources (Local DOR) 104 (shown in FIG. 1). Client 102 also includes user interaction devices such as a display 210 and a keyboard 212.

Server 202 is also communicatively coupled to network 112 via a network interface 214. Server 202 includes a system memory 216 that is electrically coupled to a system bus (not shown) and, in one embodiment, includes an operating system. In the exemplary embodiment, memory 216 includes one or more of a set of distributed applications 108 (shown in FIG. 1) that include, for example, but without limitation, publisher 118 and I/O engine 120 (both shown in FIG. 1). In an alternative embodiment, each distributed application 108 may be hosted by a separate server 202. In the exemplary embodiment, server 202 includes global directory of resources (Global DOR) 106. In one alternative embodiment, Global DOR 106 hosted by a separate server 202. In another alternative embodiment, Global DOR is hosted by a plurality of servers 202 in a clustered and/or redundant configuration.

Architecture 200 also includes at least one device 204 that is communicatively coupled to network 112. In the exemplary embodiment, architecture 200 includes a plurality of devices 204. Each device 204 may be an automation system device such as, but not limited to, a paint machine and/or a data sensor.

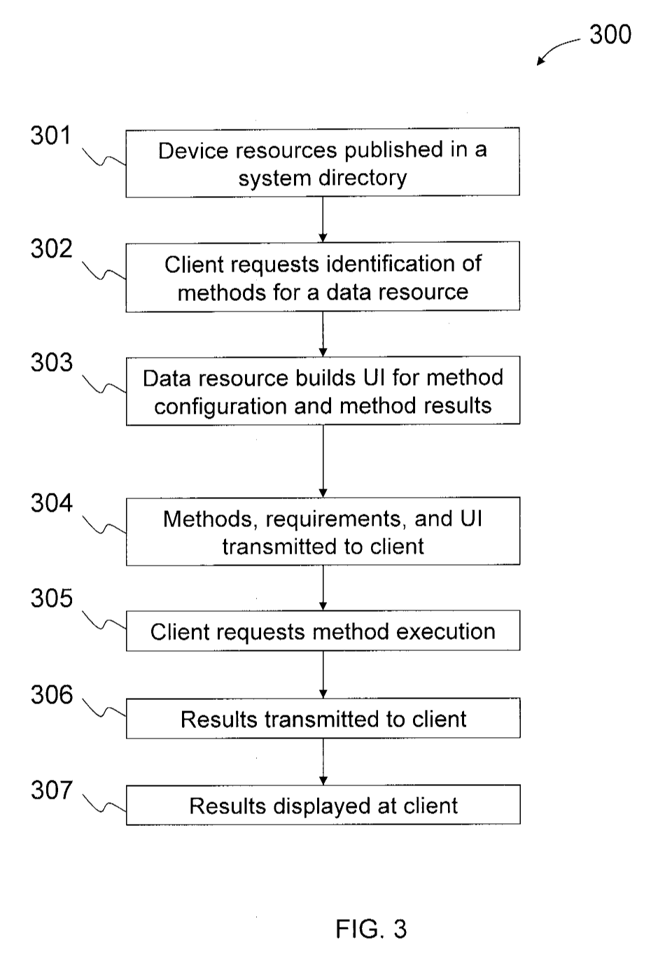

FIG. 3 is a flow chart illustrating an exemplary method 300 for communication in an automation system. In the exemplary embodiment, each data resource 110 (shown in FIG. 1) must be published 301 in Global DOR 106 (shown in FIG. 1). In doing so, publisher 118 (shown in FIG. 1) queries each data source 110 for resources to publish. Publisher 118 interacts with the Browse IF 122 (shown in FIG. 1) interface of data source 110 for this communication. Data source 110 replies to the query of publisher 118 with a list of resources to be published. The list of resources includes, but is not limited to, configuration parameters and methods available for execution. The resources for each data source 110 are then published 301 in Global DOR 106.

During normal operations, each client 102 (shown in FIG. 1) may include a number of active applications at any given time. One such application may be a browser that enables client 102 to browse for a desired data resource 110 in Local DOR 104 (shown in FIG. 1). A client application requests data from data sources 110 through the distributed applications 108 (shown in FIG. 1) via Data IF 126 (shown in FIG. 1). For example, in the exemplary embodiment, client 102 requests 302 a list of methods available for execution for a data resource 110. The individual requests to distributed applications 108 are queued in an input/output (I/O) engine 120 (shown in FIG. 1) that aggregates all outstanding requests to distributed applications 108. I/O engine 120 collects the individual Data IF requests and creates batch data packets for each respective data source 110. Each batch data packet is sent to the respective data source 110, where the batch data packets are unpacked. Data source 110 then repackages the results into another batch data packet and sends the packet to I/O engine 120. Upon receiving the batch data packet, I/O engine 120 unpacks the batch data packets and sends the individual results to client 102 from which the request originated. When a request for available methods is made 302, data resource 110 builds 303 a UI for configuring a method and/or for displaying method execution results. To accomplish this, distributed applications 108 communicate with Config IF 128 (shown in FIG. 1) interface of data resource 110. Data resource 110 returns 304 results including, for example, the programming functionality of the data resource 110, the programming functionality of each available method, parameters associated with each method, return value types for each method, and/or a UI that client 102 uses to configure a method and/or display method execution results.

After receiving a list of executable methods for a desired data resource 110, client 102 requests 305 that a desired method be executed. Because client 102 has already received the programming functionality of the desired method and parameters associated with the method, request 305 includes the required parameters. Similar to request 302, distributed applications 108 interact with I/O engine 120 and Data IF 126 to issue the request to data resource 110. After client 102 requests 305 that the desired method be executed, data resource 110 executes the desired method. The results are transmitted 306 to client 102, again using Data IF 126 and I/O engine 120 as described above. The results are then displayed 307 by client 102 for the user using, for example, client display 210 (shown in FIG. 2). More specifically, in one embodiment, client 102 displays 307 the results using the UI transmitted 304 to client 102 by data source 110. In an alternative embodiment, client 102 displays 307 the results in a UI generated by client 102.

In summary, systems and methods for accessing data in an automation system are provided. In the exemplary embodiment, a method includes publishing at least one resource for at least one device. In one embodiment, publishing a resource for a device includes registering the device in a system directory, extracting a list of available resources using an interface of the device, and displaying the available resources of the device in the system directory.

Moreover, the in the exemplary embodiment, the method includes transmitting, from a client to the device, a request to identify any available operations for the published resource. In one embodiment, transmitting such a request includes using an interface of the device to identify the programming functionality of the published resource. The programming functionality identified using the interface includes at least one of an operation that may be executed, a parameter associated with the operation, and return value information associated with the operation.

In the exemplary embodiment, the method also includes transmitting to the client a user interface generated by the device in response to a client request for information relating to a chosen operation of the published resource. In one embodiment, transmitting a user interface to the client includes using an interface of the device to generate a user interface based on the operation selected for execution and an output type associated with the selected operation, determining parameters required to execute the selected operation, generating a user interface to include parameter user interface elements and/or result user interface elements, and transmitting the user interface to the client.

Additionally, in the exemplary embodiment, the method includes displaying results of the chosen operation in response to a client request to execute the chosen operation. In one embodiment, displaying the results includes executing the chosen operation, transmitting to the client the results of the chosen operation, and displaying the results using one of the user interface received by the client and a user interface provided by the client.

The above-described systems and methods facilitates normalizing configuration and runtime data communication within a system. More specifically, the systems and methods facilitate enabling clients to support disparate devices and service providers within the system. Each service provider is required to support a set of interfaces that facilitate building a standard user interface across the system, even where the system includes service providers of various vendors. Additionally, response time between a client request and the deliver of results is minimized by using batched data requests. Collecting data requests and data results into batches prior to transmission across the network facilitates a minimized response time by requiring fewer transmissions to be made.

Exemplary embodiments of systems and methods for normalizing communication between clients and service providers are described above in detail. The systems and methods are not limited to the specific embodiments described herein, but rather, components of the systems and/or steps of the methods may be utilized independently and separately from other components and/or steps described herein. Further, the described system components and/or method steps can also be defined in, or used in combination with, other systems and/or methods, and are not limited to practice with only the systems and methods as described herein.

While the invention has been described in terms of various specific embodiments, those skilled in the art will recognize that the invention can be practiced with modification within the spirit and scope of the claims.

What is claimed is:

1. A method for accessing data in an automation system, said method comprising:
publishing at least one resource for at least one device;
transmitting, from a client to the at least one device, a request to identify any available operations for the at least one published resource;
transmitting to the client a user interface generated by the at least one device in response to a client request for information relating to a chosen operation of the at least one published resource; and
displaying results of the chosen operation in response to a client request to the at least one published resource to execute the chosen operation.

2. A method in accordance with claim 1 wherein publishing at least one resource comprises:
registering the at least one device in a system directory;
extracting a list of available resources using an interface of the at least one device; and
displaying the available resources of the at least one device in the system directory.

3. A method in accordance with claim 1 wherein transmitting, from a client to the at least one device, a request to identify any available operations further comprises using an interface of the at least one device to identify at least one of the programming functionality of the at least one published resource, wherein the programming functionality includes at least one of an operation that may be executed, a parameter associated with the operation, and return value information associated with the operation.

4. A method in accordance with claim 1 wherein transmitting to the client a user interface comprises:
using an interface of the at least one device to generate the user interface based on the operation chosen for execution and at least one output type associated with the chosen operation;
determining parameters required to execute the chosen operation;
generating the user interface to include at least one of parameter user interface elements and result user interface elements; and
transmitting the user interface to the client.

5. A method in accordance with claim 1 wherein displaying results of the chosen operation comprises:
executing the chosen operation;
transmitting the results of the chosen operation to the client; and
displaying the results using one of the user interface received by the client and a user interface provided by the client.

6. An automation communication system comprising:
a network;
at least one client device communicatively coupled to said network;
at least one service provider comprising a plurality of methods and resources, said at least one service provider communicatively coupled to said network; and
at least one server communicatively coupled to said network, said at least one server configured to:
extract and publish in a directory each available method and resource using an interface of said at least one service provider;
transmit to said at least one service provider a request from said at least one client device for a list of said plurality of methods;
transmit to said at least one client device a user interface developed by said at least one service provider, the user interface one of a method configuration user interface and a method results user interface; and
transmit to said at least one client device data results for display, wherein the data results are generated in response to a request from said at least one client device to execute a particular method of said plurality of methods.

7. An automation communication system in accordance with claim 6 wherein said at least one client device comprises at least one of a web browser and a client application, said at least one client device is configured to interact with said at least one server and said at least one service provider.

8. An automation communication system in accordance with claim 6 wherein said at least one service provider further comprises at least one interface, said at least one service provider configured to reply to a request from said at least one server with a list of available resources to be published.

9. An automation communication system in accordance with claim 8 wherein said at least one service provider is further configured to reply to a request from said at least one server for an identification of programming functionality of the particular method, wherein the programming functionality includes at least one parameter value and at least one return values associated with the particular method.

10. An automation communication system in accordance with claim 8 wherein said at least one service provider is further configured to:
determine required parameters for executing a particular method chosen by said at least one client device; and
transmit the required parameters to said at least one server.

11. An automation communication system in accordance with claim 8 wherein said at least one service provider is further configured to:
generate at least one user interface portion including at least one parameter element and at least one result element; and
transmit the at least one user interface portion to said at least one server.

12. An automation communication system in accordance with claim 8 wherein said at least one service provider is further configured to reply to a request to execute the particular method by transmitting results to said at least one server.

13. An automation communication system in accordance with claim 12 wherein said at least one client device is further configured to:
receive, separately, the particular method execution results and the user interface developed by said at least one service provider; and
display the method execution results using one of the user interface developed by said at least one service provider and a user interface provided by said at least one client.

14. A system for normalizing data access by clients in an automation system, said system comprising:
a network;
at least one client communicatively coupled to said network;
at least one device comprising a plurality of public resources and at least one interface, said at least one device communicatively coupled to said network; and
at least one application server communicatively coupled to said network, said at least one application server comprising:
a publisher configured to extract and publish in a directory each available public resource using said at least one interface of said at least one device; and
an I/O engine configured to:
provide to said at least one client an attribute list for a specific public resource and a list of methods that may be executed by said specific public resource;
provide to said at least one client a customized user interface panel generated by said specific public resource; and
provide data results to said at least one client in response to a request from said at least one client to execute a specific method by said at least one device, wherein the data results are displayed to a user using one of said customized user interface panel and a user interface provided by said at least one client.

15. A system in accordance with claim 14 wherein said at least one device is configured to transmit to said publisher the identity of each public resource of said plurality of public resources, said publisher further configured to publish the identify of each returned public resource in a system directory.

16. A system in accordance with claim 15 wherein said at least one device is further configured to transmit to said I/O engine an identification of programming functionality of the specific method and a configuration user interface, wherein the programming functionality includes at least one parameter and at least one return value associated with the specific method, and wherein the configuration user interface is transmitted to said at least one client for use in configuring the at least one parameter for the specific method.

17. A system in accordance with claim 15 wherein said at least one device is further configured to transmit to said I/O engine required input parameters for executing the specific method.

18. A system in accordance with claim 15 wherein said at least one device is further configured to generate at least one user interface portion relating to the specific method and to transmit said at least one user interface portion to said I/O engine.

19. A system in accordance with claim 15 wherein said at least one device is further configured to execute the specific method and to transmit the data results to said I/O engine.

20. A system in accordance with claim 14 wherein said at least one client is configured to receive the data results separately from said at least one user interface portion and to display the data results using one of the at least one user interface portion and the user interface provided by said at least one client.
